(19) United States
(12) Patent Application Publication
(10) Pub. No.: US 2015/0333315 A1
(43) Pub. Date: Nov. 19, 2015

(54) NEGATIVE ELECTRODE AND LITHIUM BATTERY INCLUDING THE SAME

(71) Applicant: SAMSUNG SDI CO., LTD., Yongin-si (KR)

(72) Inventors: Duk-Hyoung YOON, Yongin-si (KR); So-Ra LEE, Yongin-si (KR); Hye-Ri EOM, Yongin-si (KR)

(21) Appl. No.: 14/665,217

(22) Filed: Mar. 23, 2015

(30) Foreign Application Priority Data
May 13, 2014 (KR) 10-2014-0057442

(51) Int. Cl. H01M 4/131; H01M 4/62; H01M 4/505; H01M 4/38; H01M 4/54; H01M 4/525

(52) U.S. Cl. CPC H01M 4/131; H01M 4/54; H01M 4/525; H01M 4/505; H01M 4/386; H01M 4/623; H01M 2004/027

(57) ABSTRACT

A negative electrode for a lithium battery includes a current collector and a negative active material layer on at least one surface of the current collector. The negative active material layer includes a metal nanoparticle, a carbonaceous material, and a titanium-containing oxide. The density of the negative active material layer is greater than 1.5 g/cc and less than 3 g/cc.

### CROSS-REFERENCE TO RELATED APPLICATION

Korean Patent Application No. 10-2014-0057442, filed on May 13, 2014, in the Korean Intellectual Property Office, and entitled: “Negative Electrode and Lithium Battery Including the Same,” is incorporated by reference herein in its entirety.

### BACKGROUND

1. Field

One or more embodiments relate to a negative electrode and a lithium battery including the same.

2. Description of the Related Art

A lithium secondary battery produces electric energy when an organic electrolyte or a polymer electrolyte is used to fill between a positive electrode and a negative electrode including an active material which allows for intercalation and de-intercalation of lithium ions, through an oxidation-reduction reaction taking place when the lithium ion is intercalated/de-intercalated to and from the positive electrode and the negative electrode.

### SUMMARY

Embodiments are directed to a negative electrode for a lithium battery, including a current collector and a negative active material layer on at least one surface of the current collector. The negative active material layer includes a metal nanoparticle, a carbonaceous material, and a titanium-containing oxide. The density of the negative active material layer is greater than 1.5 g/cc and less than 3 g/cc.

The titanium-containing oxide may include a lithium titanium oxide represented by Formula 1 below:

LiₓTi_{y}M_{z}Oₙ <Formula 1>

wherein, in Formula 1, 1≦x≦4, 1≦y≦5, 0≦z≦3, and 3≦n≦12, and M is at least one element selected from the group of Li, Mg, Al, Ca, Sr, Cr, V, Fe, Co, Ni, Zr, Zn, Si, P, S, Y, Nb, Ga, Sn, Mo, W, Ba, La, Ce, Ag, Ta, Hf, Ru, Bi, Sb, and As.

The titanium-containing oxide may include at least one lithium titanium oxide selected from the group of Li₂TiO₃, Li₄Ti₅O₁₂, Li₂Ti₃O₇, LiCrTiO₄, LiFeTiO₄, Li₂TiSiO₅, LiTiPO₅, and LiTi₂(PO₄)₃.

The titanium-containing oxide may include a compound represented by Formula 2 below:

Ti_{y}M_{z}Oₙ <Formula 2>

wherein, in Formula 2, 1≦y≦2, 0≦z≦2, and 1≦n≦7, and M is at least one element selected from the group of Li, Mg, Al, Ca, Sr, Cr, V, Fe, Co, Ni, Zr, Zn, Si, P, S, Y, Nb, Ga, Sn, Mo, W, Ba, La, Ce, Ag, Ta, Hf, Ru, Bi, Sb, and As.

The titanium-containing oxide may include at least one compound selected from the group of TiO₂, TiSO₅, and TiP₂O₇.

The titanium-containing oxide may include a compound represented by Formula 3 below:

Liₓ₊₃Ti_{y}O₁₂ <Formula 3>

wherein, in Formula 3, 2.4≦x≦4.2, and 4.8≦y≦6.6.

The titanium-containing oxide be an inactive material that does not intercalate or deintercalate lithium ions during charging and discharging of the lithium battery.

The titanium-containing oxide may have electric conductivity.

An amount of the titanium-containing oxide may be in a range of from about 1 wt % to about 20 wt % of a total weight of the negative active material layer.

The metal nanoparticle may include at least one selected from the group of Si, Sn, Al, Ge, Pb, Bi, Sb, an alloy thereof, and an oxide thereof.

The metal nanoparticle may include Si or SiOₓ (0≦x≦2).

The metal nanoparticle may be include a carbon coating layer thereon.

An amount of the metal nanoparticle may be from about 0.1 wt % to about 50 wt % of a total weight of the negative active material layer.

The carbonaceous material may include a crystalline carbon, an amorphous carbon, or a mixture thereof.

An amount of the carbonaceous material may be from about 50 wt % to about 90 wt % of the total weight of the negative active material layer.

The negative active material layer may further include a binder.

The binder may be selected from the group of polyvinylidenefluoride, polyvinylidenechloride, polybenzimidazole, polyimide, polyvinylacetate, polyacrylonitrile, polyvinylalcohol, carboxyl methyl cellulose (CMC), starch, hydroxypropyl cellulose, reclaimed cellulose, polyvinylpyrrolidone, tetrafluoroethylene, polyethylene, polypropylene, polystyrene, poly(methyl methacrylate, polyaniline, acrylonitrile-butadiene styrene resin, phenol resin, epoxy resin, polyethylene terephthalate, polytetrafluoroethylene, poly(phenylene sulfide), polyamidimide, polyether imide, polyethylene sulfone, polyamide, polyacetal, poly(phenylene oxide), polybutylene terephthalate, ethylene propylene diene monomer (EPDM), sulfonated EPDM, styrene-butadiene rubber (SBR), fluoro rubber, and a combination thereof.

The negative active material layer may further include a conductive material.

Embodiments are also directed to a lithium battery that includes the negative electrode.

### BRIEF DESCRIPTION OF THE DRAWINGS

Features will become apparent to those of skill in the art by describing in detail exemplary embodiments with reference to the attached drawings in which:

FIG. 1 illustrates a schematic diagram showing a representative structure of a lithium battery structure according to an embodiment;

FIG. 2 illustrates a graph showing the capacity retention ratio of the lithium batteries prepared in Comparative Examples 5 and 6 according to C-rates;

FIG. 3 illustrates a graph showing the capacity retention ratio of the lithium batteries prepared in Example 3 and Comparative Example 7 according to C-rates; and

FIG. 4 illustrates a graph showing the capacity retention ratio of the lithium battery prepared in Example 3 at each cycle.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

A negative electrode according to an embodiment includes a current collector and a negative active material layer disposed on at least one surface of the current collector, wherein the negative active material layer includes a metal nanoparticle, a carbonaceous material, and a titanium-containing oxide, and the density of the negative active material layer is higher than 1.5 g/cc and lower than 3 g/cc. The term “density (g/cc) of an active material layer” herein used refers to mass per volume of an active material layer, also called “mix density,” and is a index which represents the pressure applied to an electrode plate during the rolling process.

According to an example, the titanium-containing oxide may include a lithium titanium oxide represented by Formula 1 below:

LiₓTi_{y}M_{z}Oₙ <Formula 1>

In Formula 1, 1≦x≦4, 1≦y≦5, 0≦z≦3, and 3≦n≦12, and M is at least one element selected from the group of lithium (Li), magnesium (Mg), aluminum (Al), calcium (Ca), strontium (Sr), chromium (Cr), vanadium (V), iron (Fe), cobalt (Co), nickel (Ni), zirconium (Zr), zinc (Zn), silicon (Si), phosphorus (P), sulfur (S), yttrium (Y), niobium (Nb), gallium (Ga), tin (Sn), magnesium (Mo), tungsten (W), barium (Ba), lanthanum (La), cerium (Ce), silver (Ag), tantalum (Ta), hafnium (Hf), ruthenium (Ru), bismuth (Bi), antimony (Sb), and arsenic (As).

According to one example, the titanium-containing oxide may include at least one lithium titanium oxide selected from the group of Li₂TiO₃, Li₄Ti₅O₁₂, Li₂Ti₃O₇, LiCrTiO₄, LiFeTiO₄, Li₂TiSiO₅, LiTiPO₅, and LiTi₂(PO₄)₃.

For example, the titanium-containing oxide may include Li₄Ti₅O₁₂.

According to an example, the titanium-containing oxide may include a compound represented by Formula 2 below:

Ti_{y}M_{z}Oₙ <Formula 2>

In Formula 2, 1≦y≦2, 0≦z≦2, and 1≦n≦7, and M is at least one element selected from the group of Li, Mg, Al, Ca, Sr, Cr, V, Fe, Co, Ni, Zr, Zn, Si, P, S, Y, Nb, Ga, Sn, Mo, W, Ba, La, Ce, Ag, Ta, Hf, Ru, Bi, Sb, and As.

According to an example, the titanium-containing oxide may include at least one compound selected from the group of TiO₂, TiSO₅, and TiP₂O₇.

According to an example, the titanium-containing oxide may include a compound represented by Formula 3 below:

Liₓ₊₃Ti_{y}O₁₂ <Formula 3>

In Formula 3, 2.4≦x≦4.2, and 4.8≦y≦6.6.

According to an example, the titanium-containing oxide may act as an inactive material that does not intercalate or deintercalate lithium ions during charging and discharging of a lithium battery. For example, a compound represented by Formula 3 may be a structure into which lithium ions are intercalated during an initial charge of a battery. The compound may maintain the structure represented by Formula 3 in which the structure includes an intercalated lithium ion, in that no more lithium ions may be intercalated or de-intercalated despite repeated charging/discharging.

For example, when a battery including the negative electrode is discharged, lithium ions intercalated during battery charging are de-intercalated from a metal nanoparticle and a carbonaceous material. A discharge cut-off voltage may be set up for a titanium-containing oxide such that lithium ions intercalated during battery charging are not be de-intercalated. Therefore, a titanium-containing oxide may maintain the structure represented by Formula 3 in which the structure includes an intercalated lithium ion.

The compound represented by Formula 3 may be formed by intercalating lithium ions to a lithium titanium oxide represented by Formula 4 below:

LiₓTi_{y}O₁₂ <Formula 4>

In Formula 4, 2.4≦x≦4.2, and 4.8≦y≦6.6.

For example, the titanium-containing oxide may include Li₇Ti₅O₁₂, which is formed by intercalating lithium ions to Li₄Ti₅O₁₂.

In addition, the titanium-containing oxide may have electric conductivity. The titanium-containing oxide may play the role of a conductive material to decrease the resistance of a battery including the negative electrode. Therefore, an additional conductive material besides the titanium-containing oxide may be omitted from the negative active material layer.

The content of the titanium-containing oxide may be from about 1 wt % to about 20 wt % of the total weight of the negative active material layer. For example, the content of the titanium-containing oxide may be from about 1 wt % to about 15 wt % of the total weight of the negative active material layer. For example, the content of the titanium-containing oxide may be from about 5 wt % to about 15 wt % of the total weight of the negative active material layer. Within the range, due to the weight and volume of the titanium-containing oxide which may exist as a non-active material, the lithium storage capacity of a negative electrode may not decrease, and high-rate characteristics may be improved even when the density of the high negative active material layer is high.

The metal nanoparticle may include at least one selected from the group of Si, Sn, Al, Ge, Pb, Bi, Sb, an alloy thereof, and an oxide thereof.

Herein, for purposes of defining a metal nanoparticle, a nanoparticle including or made up entirely of silicon, which has a maximum theoretical capacity of about 4020 mAh/g and thereby may exhibit high capacity, may be considered as a metal nanoparticle. Thus, for example, the metal nanoparticle may be an Si nanoparticle.

For example, the metal nanoparticle may be a Si—Y alloy (Y is an alkali metal, an alkali earth metal, a Group 13 element, a Group 14 element, a transition metal, a rate earth metal, or a combination thereof, and is not Si.) or a Sn—Y alloy (Y is an alkali metal, an alkali earth metal, a Group 13 element, a Group 14 element, a transition metal, a rate earth metal, or a combination thereof, and is not Sn). The Y element may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof.

For example, the metal nanoparticle may be an oxide such as SnO₂ or SiOₓ (0<x<2).

The metal nanoparticle may be a metal nanoparticle including a carbon coating layer.

For example, the metal nanoparticle may be coated with a carbonaceous material. The carbonaceous material may include an amorphous carbon. The amorphous carbon may be selected from the group of soft carbon, hard carbon, mesophase pitch carbide, calcinated coke, nano-carbon fiber, and a mixture thereof.

A method of coating the metal nanoparticle with the carbon coating layer may include a dry coating method or a wet coating method, as examples. For example, chemical vapor deposition (CVD) and evaporation may be used as the dry coating method, and impregnation and spraying may be used as the wet coating method. When the wet coating method is used, dimethyl sulfoxide (DMSO) or tetrahydrofuran (THF) may be used as a solvent.

The total weight of metal nanoparticles present in the negative active material layer may be from about 0.1 wt % to about 50 wt % of the total weight of the negative active material layer. For example, the total weight of the metal nanoparticle may be from about 1 wt % to about 30 wt % of the total weight of the negative active material layer. Within the range, structural stability of a negative electrode may be secured, and a high-capacity battery may be realized.

The carbonaceous material may include a crystalline carbon, an amorphous carbon, or a mixture thereof.

The crystalline carbon may be amorphous, plate, flake, spherical, or fibrous natural graphite, or artificial graphite prepared by carbonizing coal pitch or petroleum pitch. The amorphous carbon may be soft carbon, hard carbon, mesophase pitch carbide, or calcinated coke, as examples.

The total weight of the carbonaceous material may be from about 50 wt % to about 90 wt % of the total weight of the negative active material layer. Within the range, structural stability of a negative electrode may be secured, and negative active material layer density over a certain level may be realized.

The negative active material layer may further include a binder.

The binder may be an aqueous binder.

For example, the binder may be selected from the group of polyvinylidenefluoride, polyvinylidenechloride, polybenzimidazole, polyimide, polyvinylacetate, polyacrylonitrile, polyvinylalcohol, carboxyl methyl cellulose (CMC), starch, hydroxypropyl cellulose, reclaimed cellulose, polyvinylpyrrolidone, tetrafluoroethylene, polyethylene, polypropylene, polystyrene, poly(methyl methacrylate, polyaniline, acrylonitrile-butadiene styrene resin, phenol resin, epoxy resin, polyethylene terephthalate, polytetrafluoroethylene, poly(phenylene sulfide), polyamidimide, polyether imide, polyethylene sulfone, polyamide, polyacetal, poly(phenylene oxide), polybutylene terephthalate, ethylene propylene diene monomer (EPDM), sulfonated EPDM, styrene-butadiene rubber (SBR), fluoro rubber, and a combination thereof. The total weight of the binder may be from about 1 to about 50 parts by weight, for example, from about 1 to about 30 parts by weight, from about 1 to about 20 parts by weight, or from about 1 to about 15 parts by weight based on 100 parts by weight of the total weight of a metal nanoparticle, which may serve as a negative active material, a carbonaceous material, and a titanium-containing oxide.

The binder may contribute to binding of the metal nanoparticle with a current collector, binding of a titanium-containing oxide with the current collector, and binding of the metal nanoparticle with a conductive material.

The negative active material layer may further include a conductive material. The conductive material may provide a conductive pathway to the metal nanoparticle, the carbonaceous material, and the titanium-containing oxide to improve electric conductivity. Any suitable conductive material may be used as the conductive material. Examples of the conductive material include a carbonaceous material such as carbon black, acetylene black, Ketjen black, and carbon fiber, a metal material such as metal powder or metal fiber formed by using copper, nickel, aluminum, or silver, a conductive polymer such as a polyphenylene derivative; and a combination thereof. The content of the conductive material may be appropriately adjusted. For example, the weight ratio of the sum of the metal nanoparticle, the carbonaceous material, and the titanium-containing oxide to the conductive material may be from about 99:1 to about 90:10.

A suitable current collector that has high electric conductivity and does not cause a chemical change to the battery may be used. For example, the current collector may be formed by using at least one material selected from the group of aluminum, copper, nickel, titanium, and stainless steel. The surface of the aluminum, copper, nickel, titanium, or stainless steel material may be treated by electroplating or ion deposition using a coating component such as nickel, copper, aluminum, titanium, gold, silver, platinum, and palladium, or the surface may be coated with the coating component by dipping. Nanoparticles of the coating component may be compressed, and the resulting material may be used as a basic material. In some implementations, the current collector may be formed by coating a conductive material on a base material made of a non-conductive material.

The current collector may have a surface having a fine uneven structure. The fine uneven structure may contribute to an increase in adhesiveness with respect to an active material layer that is used to coat a substrate. The current collector may be variously shaped, and may be, for example, a film, sheet, foil, net, porous body, foam, or felt. The thickness of the current collector may be, for example, from about 3 μm to about 500 μm.

A lithium battery according to another aspect includes the negative electrode described above.

Hereinafter, a method of preparing the lithium battery described above is described.

A method of preparing the lithium battery may include providing a lithium battery structure including a positive electrode, a negative electrode, a separator interposed between the positive electrode and the negative electrode, and an electrolyte. Providing a lithium battery structure may include preparing a negative active material composition including a metal nanoparticle, a carbonaceous material, and a titanium-containing oxide, coating a current collector with the negative active material composition to prepare a current collector coated with the negative active material composition, and drying and rolling the current collector coated with the negative active material composition to prepare a negative electrode including a negative active material layer formed on the current collector, wherein the density of the negative active material layer is higher than 1.5 g/cc and lower than 3 g/cc.

Providing a lithium battery structure including a positive electrode, a negative electrode, a separator interposed between the positive electrode and the negative electrode, and an electrolyte is described below.

The negative electrode may be prepared as follows.

The metal nanoparticle, the titanium-containing oxide, the carbonaceous material, and, selectively, a binder and conductive material, may be dispersed in a solvent to prepare a negative active material composition.

Subsequently, the negative active material composition may be coated onto a current collector to prepare a current collector, at least one surface of which is coated with the negative active material composition. The coating may be performed by directly coating a current collector with the negative active material composition or by casting the negative active material composition onto a separate support and laminating a current collector with a negative active material composition film peeled off from the support.

The current collector coated with the negative active material composition may be dried at a temperature from about 80° C. to about 120° C. and then rolled to prepare a negative electrode including a negative active material layer having a density higher than 1.5 g/cc and lower than 3 g/cc.

According to one example, the metal nanoparticle, the titanium-containing oxide, the carbonaceous material, the binder, and the conductive material included in the negative active material composition are the same as those described above.

According to one example, the titanium-containing oxide included in the negative active material composition may include a lithium titanate represented by Formula 4 below:

LiₓTi_{y}O₁₂ <Formula 4>

In Formula 4, 2.4≦x≦4.2, and 4.8≦y≦6.6.

The titanium-containing oxide represented by Formula 4 may be a compound represented by Formula 3 above before lithium ions are intercalated into the compound.

For example, the titanium-containing oxide represented by Formula 4 may include Li₄Ti₅O₁₂.

As the solvent, N-methylpyrrolidone (NMP), acetone, or water may be used. The content of the solvent may be from about 1 to about 400 parts by weight based on 100 parts by weight of a positive electrode active material. When the content of the solvent is within the above range, an active material layer may be easily formed.

Next, the positive electrode may be prepared by the same method of preparing the negative electrode, except that a positive electrode active material is used instead of the metal nanoparticle, the titanium-containing oxide, and the carbonaceous material of the negative electrode. In addition, to prepare a positive electrode active material composition, a binder, a conductive material, and a solvent that are the same as those of the negative electrode may be used.

For example, a positive electrode active material, a binder, and, selectively, a conductive material, may be dispersed in a solvent to prepare a positive electrode active material composition. Subsequently, a current collector having at least one surface that is coated with a positive electrode active material composition may be prepared by directly coating a current collector with the negative active material composition or by casting the positive electrode active material composition onto a separate support and laminating a current collector with a positive electrode active material composition film peeled off from the support. The current collector coated with the positive electrode active material composition may be dried and rolled to prepare a positive electrode including a positive electrode active material layer.

Any suitable positive electrode active material may be used as the positive electrode active material. For example, the following compounds may be independently used as a first positive electrode active material and a second positive electrode active material. For example, a compound represented by a Formula selected from the group of LiₐA_{1-b}B_{b}D₂ (0.90≦a≦1, and 0≦b≦0.5); LiₐE_{1-b}B_{b}O_{2-c}D_{c} (0.90≦a≦1, 0≦b≦0.5, and 0≦c≦0.05); LiE_{2-b}B_{b}O_{4-c}D_{c} (0≦b≦0.5, and 0≦c≦0.05); LiₐNi_{1-b-c}Co_{b}B_{c}Dₐ (0.90≦a≦1, 0≦b≦0.5, 0≦c≦0.05, and 0≦a≦2); LiₐNi_{1-b-c}Co_{b}B_{c}O_{2-α}F_{α} (0.90≦a≦1, 0≦b≦0.5, 0≦c≦0.05, and 0≦α≦2); LiₐNi_{1-b-c}Co_{b}B_{c}O_{2-α}F₂ (0.90≦a≦1, 0≦b≦0.5, 0≦c≦0.05, and 0≦α≦2); LiₐNi_{1-b-c}Mn_{b}B_{c}D_{α} (0.90≦a≦1, 0≦b≦0.5, 0≦c≦0.05, and 0≦α≦2); LiₐNi_{1-b-c}Mn_{b}B_{c}O_{2-α}F_{α} (0.90≦a≦1, 0≦b≦0.5, 0≦c≦0.05, and 0≦α≦2); LiₐNi_{1-b-c}Mn_{b}B_{c}O_{2-α}F₂ (0.90≦a≦1, 0≦b≦0.5, 0<c≦0.05, and 0≦α≦2); LiₐNi_{b}E_{c}G_{d}O₂ (0.90≦a≦1, 0≦b≦0.9, 0≦c≦0.5, and 0.001≦d≦0.1); LiₐNi_{b}Co_{c}Mn_{d}GeO₂ (0.90≦a≦1, 0≦b≦0.9, 0≦c≦0.5, 0≦d≦0.5, and 0.001≦e≦0.1); LiₐNiG_{b}O₂ (0.90≦a≦1, and 0.001≦b≦0.1); LiₐCoG_{b}O₂ (0.90≦a≦1, and 0.001≦b≦0.1); LiₐMnG_{b}O₂ (0.90≦a≦1, and 0.001≦b≦0.1); LiₐMn₂G_{b}O₄ (0.90≦a≦1, and 0.001≦b≦0.1); QO₂; QS₂; LiQS₂; V₂O₅; LiV₂O₅; LiIO₂; LiNiVO₄; Li_{(3-f)}J₂(PO₄)₃ (0≦f≦2); Li_{(3-f)}Fe₂(PO₄)₃ (0≦f≦2); and LiFePO₄ may be used.

In the Formulas above, the letters A, B, D, E, F, G, and J are used as variables to represent elements as further defined. In particular, A is nickel (Ni), cobalt (Co), manganese (Mn), or a combination thereof; B is aluminum (Al), Ni, Co, Mn, chromium (Cr), iron (Fe), Mg, strontium (Sr), vanadium (V), a rare earth metal element, or a combination thereof; D is oxygen (O), fluorine (F), sulfur (S), phosphorus (P), or a combination thereof; E is Co, Mn, or a combination thereof; F is fluorine, S, P, or a combination thereof; G is Al, Cr, Mn, Fe, Mg, lanthanum (La), cerium (Ce), Sr, V, or a combination thereof; Q is Ti, molybdenum (Mo), Mn, or a combination thereof; I is Cr, V, Fe, Sc, Y, or a combination thereof; and J is V, Cr, Mn, Co, Ni, Cu, or a combination thereof.

For example, the positive electrode active material may be LiCoO₂, LiMnₓO₂ₓ (x=1, 2), LiNi₁₋ₓMnₓO₂ₓ (0≦x≦1), LiNi_{1-x-y}CoₓMn_{y}O₂ (0≦x≦0.5, and 0≦y≦0.5), or FePO₄.

A separator, which will be interposed between the positive electrode and the negative electrode, may be prepared. Any suitable material may be used as separator. In particular, a material having low resistance to ion migration of an electrolyte and excellent electrolyte absorptivity may be appropriate. For example, the separator may be a material selected from the group of glass fiber, polyester, Teflon, polyethylene, polypropylene, polytetrafluoroethylene, and a combination thereof. For example, the separator may be in the form of felt or woven fabric. For example, a separator having a pore diameter from about 0.01 μm to about 10 μm and a thickness from about 5 μm to about 300 μm is used as the separator.

The electrolyte may include a non-aqueous electrolyte and a lithium salt. As the non-aqueous electrolyte, a non-aqueous electrolyte solution, an organic solid electrolyte, or an inorganic solid electrolyte may be used.

As the non-aqueous electrolyte solution, an aprotic organic solvent, for example, N-methyl-2-pyrrolidinone, propylene carbonate (PC), ethylene carbonate (EC), butylene carbonate, dimethyl carbonate (DMC), diethyl carbonate (DEC), gamma-butyrolactone (GBL), 1,2-dimethoxy ethane (DME), tetrahydrofuran (THF), 2-methyl tetrahydrofuran, dimethylsulfoxide (DMSO), 1,3-dioxolane (DOL), formamide, dimethylformamide, acetonitrile, nitromethane, methyl formate, methyl acetate, phosphate triester, trimethoxy methane, dioxolane derivatives, sulfolane, methyl sulfolane, 1,3-dimethyl-2-imidazolidinone, propylene carbonate derivatives, THF derivatives, ether, methyl propionate, and ethyl propionate may be used.

As the organic solid electrolyte, for example, polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers including an ionic dissociation group may be used.

As the inorganic solid electrolyte, a nitride, a halide, or a sulfate of lithium, for example, Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂, may be used.

Any suitable lithium salts for a lithium battery may be used as the lithium salt. As a material that is readily dissolved in the non-aqueous electrolyte, at least one selected from the group of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborane, lower aliphatic carboxylic acid lithium, 4-phenyl lithium borate, and imides may be used.

In addition, the electrolyte may include vinylene carbonate (VC) or catechol carbonate (CC) to form and maintain a solid electrolyte interphase (SEI) layer on a surface of a negative electrode. In an implementation, the electrolyte may include a redox-shuttle additive such as n-butyl ferrocene and halogen-substituted benzene to prevent over-charging. In an implementation, the electrolyte may include a film-forming additive such as cyclohexylbenzene and biphenyl. In an implementation, the electrolyte may include a cation receptor such as a Crown ether compound to improve conductivity and an anion receptor such as a boron compound. In an implementation, the electrolyte may include a phosphate compound such as trimethyl phosphate (TMP), tris(2,2,2-trifluoroethyl)phosphate (TFP), and hexamethoxy cyclotriphosphazene (HMTP) as a fire retardant.

In an implementation, to contribute to the formation of a stable SEI layer or a film on a surface of an electrode to improve stability of a lithium battery, the electrolyte may further include an additive, for example, tris(trimethylsilyl)phosphate (TMSP), lithium difluoro(oxalato)borate (LiFOB), propane sultone (PS), succinonitrile (SN), LiBF₄, a silane compound having a functional group which may form a siloxane bond, such as an acryl, amino, epoxy, methoxy, ethoxy, or vinyl group, and a silazane compound such as hexamethyldisilazane. For example, the electrolyte may include an additive such as PS, SN, and LiBF₄.

For example, a lithium salt such as LiPF₆, LiClO₄, LiBF₄, and LiN(SO₂CF₃)₂ may be added to a mixed solvent including a cyclic carbonate of EC or PC, which is a highly dielectric solvent, and a liner carbonate of DEC, DMC, or EMC, which is a low viscosity solvent to prepare an electrolyte.

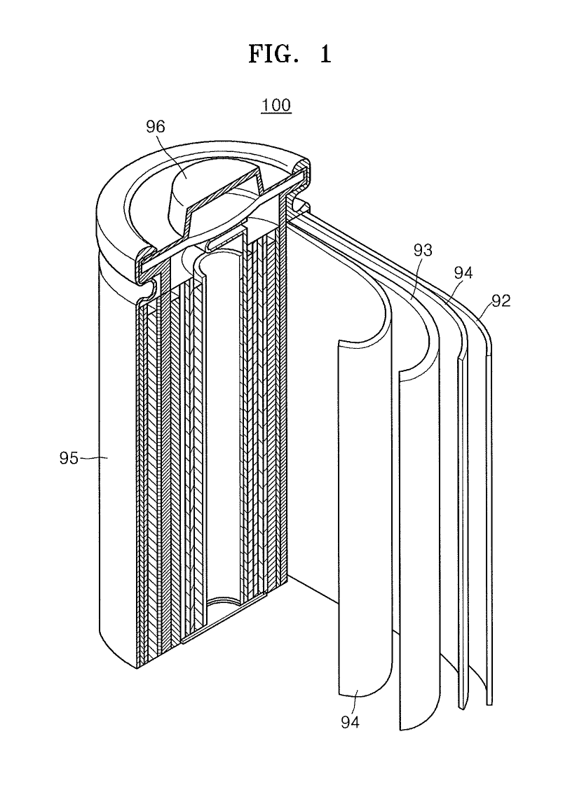

FIG. 1 illustrates a schematic diagram showing a representative structure of a lithium battery structure according to an embodiment.

As shown in FIG. 1, in the lithium battery structure 100, a positive electrode 93, a negative electrode 92, and a separator 94 interposed between the positive electrode 93 and the negative electrode 92 are installed to form a primary structure. In addition, to prevent an internal short-circuit, a separator may be additionally installed on the outer surface of the positive electrode 93 or the negative electrode 92. The primary structure may be wound or folded to fit into a cylindrical or square battery container 95. An electrolyte may be injected into the battery container 95, which is then sealed with a sealing material 96 to form the lithium battery structure 100.

A formation process may be performed on the lithium battery structure 100 to prepare a lithium battery.

The formation process may be performed to stabilize the battery structure and complete the lithium battery structure. For example, the formation process may include aging, charging, or discharging of the lithium battery structure.

In the aging process, the lithium battery structure may be impregnated with an electrolyte.

In the charging process, the lithium battery may be completely charged so that an SEI layer forms on the surface of the negative electrode. In the charging process, lithium ions may be intercalated to the metal nanoparticle and the lithium titanate particle.

For example, during the charging process, the lithium titanate particle may be converted into a compound represented by Formula 3, which is formed by intercalating lithium ions into a compound represented by Formula 4:

Liₓ₊₃Ti_{y}O₁₂ <Formula 3>

In Formula 3, 2.4≦x≦4.2, and 4.8≦y≦6.6.

The discharging process may be performed at discharge cut-off voltage of 1.5 V or less, For example, the discharging process may be performed at discharge cut-off voltage of about 0.2 V to about 1.5 V.

During the discharging process, at a voltage of 1.5 V or less, the compound represented by Formula 4 may retain a structure intercalated with lithium ions.

During the discharging process, at a voltage of 1.5 V or less, the lithium titanium oxide particles may include the compound represented by Formula 3:

Liₓ₊₃Ti_{y}O₁₂ <Formula 3>

In Formula 3, 2.4≦x≦4.2, and 4.8≦y≦6.6.

For example, when the discharging process is performed at discharge cut-off voltage of 1.5 V or less, metal nanoparticles included in the negative electrode of the lithium battery assembly may deintercalate lithium ions. However, lithium titanium oxide particles included in the negative electrode of the lithium battery assembly, at the voltage of 1.5 V or less, may not deintercalate lithium ions. In other words, at the voltage of 1.5 V or less, lithium titanium oxide particles included in the negative electrode may not be discharged, and instead, may maintain a charged form represented by Formula 3.

Therefore, after the formation process, the titanium-containing oxide may be converted to a non-active material that neither stores nor releases any lithium ions. The titanium-containing oxide may serve as an effective conductive material.

The lithium battery may be used not only as a battery that is used as a power source of a small-sized device but also as a unit battery of a medium and large-sized device battery module including a plurality of batteries.

Examples of the medium and large-sized device include a power tool; an xEV, such as an electric vehicle (EV), a hybrid electric vehicle (HEV), and a plug-in hybrid electric vehicle (PHEV); an electric two-wheeled vehicle, such as an E-bike and an E-scooter; an electric golf cart; an electric truck; an electric commercial vehicle; or an electric power storage system. In addition, the lithium battery may be used for any other usages requiring high output, high voltage, and high temperature operability.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Preparation of Negative Electrode

### Example 1

To prepare a negative active material composition, Si particles having an average particle diameter of 15 nm (Sigma Aldrich), a Li₄Ti₅O₁₂ particle having an average particle diameter of 150 nm (Samsung Fine Chemicals), graphite particles having an average particle diameter of 16 μm (Mitsubishi), and polyacrylonitrile (PAN) as a binder were mixed at a weight ratio of 6.65:9.5:78.85:5. N-methylpyrrolidone was added as a solvent so that the amount of the solid content was 60 wt %.

A copper current collector having a thickness of 15 μm was coated with the negative active material composition by a general method to provide a 40 μm thick coating of the negative active material composition on the current collector. The current collector coated with the composition was dried at room temperature, re-dried at 120° C., and then rolled to prepare a negative electrode including a negative active material layer having a density of 1.7 g/cc.

### Example 2

A negative electrode was prepared by the same method as that of Example 1, except that a TiSO₅ particle (Sigma Aldrich) having an average particle diameter of 150 nm was used.

### Comparative Example 1

A negative electrode was prepared by the same method as that of Example 1, except that a negative electrode including a negative active material layer having a density of 1.5 g/cc was prepared.

### Comparative Example 2

To prepare a negative active material composition, Si particles having an average particle diameter of 15 nm (Sigma Aldrich), graphite particles having an average particle diameter of 16 μm (Mitsubishi), and PAN as a binder were mixed at a weight ratio of 7.4:9.2:5, and N-methylpyrrolidone was added as a solvent to control the viscosity so that the amount of the solid content was 60 wt %.

A copper current collector having a thickness of 15 μm was coated with the negative active material composition by a general method to a thickness about 40 μm on the current collector. The current collector coated with the composition was dried at room temperature, re-dried at 120° C., and then rolled to prepare a negative electrode including a negative active material layer having a density of 1.5 g/cc.

### Comparative Example 3

A negative electrode was prepared by the same method as that of Comparative Example 2, except that a negative electrode including a negative active material layer having a density of 1.7 g/cc was prepared.

### Comparative Example 4

A negative electrode was prepared by the same method as that of Example 2, except that a negative electrode including a negative active material layer having a density of 1.5 g/cc was prepared.

### Preparation of Lithium Secondary Battery

### Coin Half Cell

### Example 3

The negative electrode prepared in Example 1, a lithium metal counter electrode, and a polypropylene separator having a thickness of 14 μm were used in preparing a lithium battery structure. An electrolyte was injected into the lithium battery structure and then the structure was compressed to prepare a lithium battery structure according to a 2032 standard. The electrolyte was prepared by dissolving LiPF₆ in a mixed solution of EC, DEC, and fluoroethylene carbonate (FEC) (wherein the volumetric ratio of EC:DEC:FEC was 5:70:25) to provide a LiPF₆ concentration of 1.10 M in the mixed solution.

The lithium battery assembly was initially charged at a 0.1 C rate for 10 minutes, and then, stored at a temperature of 25° C. for one day.

Thereafter, the lithium battery assembly was charged at a 0.1 C rate to a voltage of 4.2 V in a constant current (CC) mode. Subsequently, the lithium battery assembly was discharged at a 0.1 C rate to a discharge cut-off voltage of 1.5V in a CC mode to complete manufacturing of a lithium secondary battery. (Formation process)

### Example 4

A lithium secondary battery was prepared by the same method as that of Example 3, except that the negative electrode prepared in Example 2 was used.

### Comparative Examples 5 to 8

A lithium secondary battery was prepared by the same method as that of Example 3, except that the negative electrodes prepared in Comparative Examples 1 to 4 were used.

### Evaluation Example 1

### Evaluation of High-Rate Characteristics

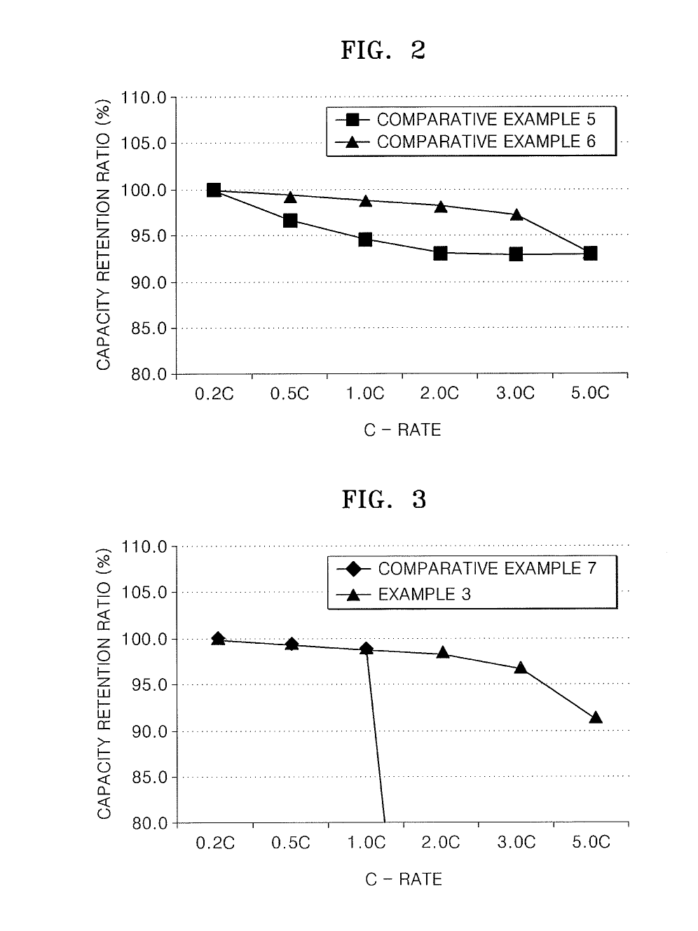

The lithium secondary batteries manufactured according to Example 3 to 4 and Comparative Examples 5 to 8 were charged at a 0.01 C rate to a maximum operating voltage in a CC mode, and then discharged at a 0.2 C rate to a discharge cut-off voltage of 1.5V in a CC mode. Then, the capacity retention ratio with respect to a C-rate of the lithium secondary batteries was measured while the lithium secondary batteries was discharged at a 0.5 C, 1.0 C, 2.0 C, 3.0 C and 5.0 C, respectively. A portion of the results is shown in FIGS. 2 and 3.

As shown in FIG. 2, the high-rate charging/discharging characteristics of the battery including a negative active material layer having a density of 1.5 g/cc were not improved, even though Li₄Ti₅O₁₂ was included in the negative electrode.

On the other hand, as shown in FIG. 3, when the density of the negative active material layer was increased to 1.7 g/cc, the high-rate charging/discharging characteristics of the battery of Comparative Example 7, in which Li₄Ti₅O₁₂ was not included in the negative electrode, were not measured at a rate higher than 1.0 C. However, the battery of Example 3, in which Li₄Ti₅O₁₂ was included in the negative electrode, showed a capacity retention ratio (CRR) of 90% or higher even at a rate of 5.0 C. Therefore, the result showed that, when Li₄Ti₅O₁₂ is included in the negative electrode, the high-rate charging/discharging characteristics may be maintained even when the density of the negative active material layer increases. This result indicates that the realizable battery capacity per time may be increased. The result also suggests that output characteristics may be improved.

### Evaluation Example 2

### Evaluation of High-Rate Lifespan

The lithium batteries which had been prepared in Examples 3 to 4 and Comparative Examples 5 to 8 were charged at a 1.0 C rate in a CC mode at a temperature of 25° C. to a voltage of 4.3 V, and then, holding the battery at 4.3 V, the lithium secondary batteries were charged in a constant voltage (CV) mode to a 0.01 C rate. Subsequently, discharging was performed at a 3.0 C rate to the voltage of 1.5V in a CC mode. A cycle of the charging and the discharging was repeatedly performed 50 times.

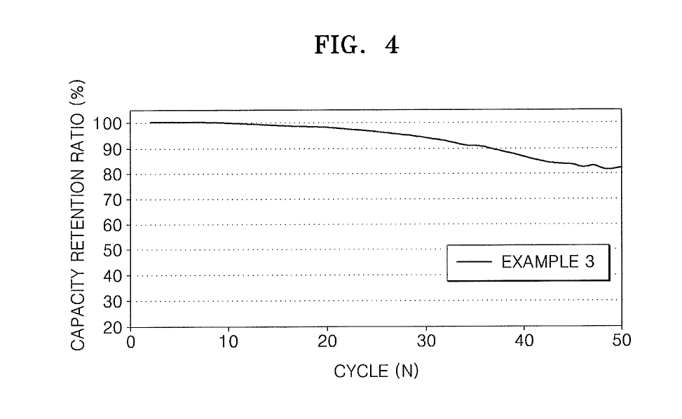

The CRR of the coin half cell was measured and is shown in Table 1 and FIG. 4. The CRR is defined by Mathematical Formula 1:

Capacity retention ratio(CRR)[%]=[Discharge capacity at each cycle/Discharge capacity at the first cycle]×100 <Mathematical Formula 1>

TABLE 1

| | Titanium-containing | Density of negative | |
|---|---|---|---|
| | oxide included in | active material | CRR at 50th |
| | negative electrode | layer (g/cc) | cycle (%) |
| Example 3 | Li₄Ti₅O₁₂ | 1.7 | 82 |
| Example 4 | TiSO₅ | 1.7 | 80 |
| Comparative | Li₄Ti₅O₁₂ | 1.5 | 78 |
| Example 5 | | | |
| Comparative | — | 1.5 | 82 |
| Example 6 | | | |
| Comparative | — | 1.7 | Impossible |
| Example 7 | | | to measure |
| Comparative | TiSO₅ | 1.5 | 78 |
| Example 8 | | | |

As shown in Table 1, the high-rate CRR rates of the batteries prepared in Comparative Example 5 and Comparative Example 8 were not higher than that of the battery prepared in Comparative Example 6.

As shown in Table 1 and FIG. 4, the high-rate CRR of the batteries prepared in Examples 3 and Example 4 was higher than that of the battery prepared in Comparative Example 7. Without being bound to any particular theory, it is believed that when a titanium-containing oxide such as Li₄Ti₅O₁₂ and TiSO₅ is included in the negative electrode, impregnability of an electrolyte is not decreased in spite of an increase of the density of the negative active material layer. Accordingly, a high rate lifespan may be improved, since

Therefore, by using a negative electrode including the titanium-containing oxide, a battery that includes a high-density negative active material layer and that provides high output may be realized.

By way of summation and review, as a negative active material of a lithium secondary battery, a carbonaceous material is frequently used. Examples of a carbonaceous material include crystalline carbons such as graphite and artificial graphite, and amorphous carbons such as soft carbon and hard carbon. However, since these carbonaceous materials have a theoretical capacity of 380 mAh/g at most, the carbonaceous materials may not be suitable for a high-capacity lithium battery.

To provide an increased capacity, metals such as silicon, tin, aluminum, germanium, and lead that may react with lithium to form an alloy, and alloys and composite related to the metals have been actively studied. A negative active material including such a non-carbonaceous material may store and release more lithium ions than a negative electrode material including a carbonaceous material. Thus, such a negative active material is considered for use in preparing a battery having high capacity and high energy density. For example, pure silicon is known to have a high theoretical capacity of 4,200 mAh/g.

In addition, as small-sized high-tech devices such as digital cameras, mobile devices, and laptop computers have developed, and a lithium secondary battery, which is an energy source of the devices, has been reduced in size. When reducing the size of a lithium secondary battery, a high-energy density battery is desirable. When the density of a negative active material layer is low, even using a material having a high capacity as the negative active material layer may not be sufficient to increase the energy density of a lithium secondary battery.

A negative electrode which enables the realization of a high capacity battery and an increase in the density of a negative active material layer is desirable.

Generally, when a negative electrode is prepared, after coating a current collector with a negative active material composition, a rolling process is implemented to increase the density of the electrode and decrease the resistance of the electrode. To decrease the thickness of the negative active material layer formed by the rolling process and to realize a high-capacity battery under a given battery volume condition, a high density of the negative active material layer is desirable.

However, when silicon or other materials are used as a negative active material to realize a high-capacity battery, when the density of the negative active material layer is increased above a certain amount, the size of pores included in the negative active material layer may decrease, and general battery physical properties such as high-rate characteristics may thereby be worsened.

According to embodiments, a titanium-containing oxide is used to provide a battery having improved high-rate characteristics and output characteristics that are maintained even when the density of the negative active material layer increases.

A negative electrode for a lithium battery according to one or more embodiments may include a current collector; and a negative active material layer disposed on at least one surface of the current collector, wherein the negative active material layer includes a metal nanoparticle, a carbonaceous material, and a titanium-containing oxide, and the density of the negative active material layer is higher than 1.5 g/cc and lower than 3 g/cc. When the titanium-containing oxide is included in a negative active material layer having a density higher than 1.5 g/cc and lower than 3 g/cc, high-rate charge-discharge characteristics of a battery may be improved.

For a battery employing a negative electrode including a negative active material layer of which density is 1.5 g/cc or less, even if the negative active material layer does not include a titanium-containing oxide, the high-rate characteristics thereof may not decrease.

However, for a comparative battery employing a negative electrode including a negative active material layer having a density higher than 1.5 g/cc, the size of pores between a metal nanoparticle and a carbonaceous material may decrease, and, as a result, impregnation of an electrolyte may become difficult. The metal nanoparticles may not contribute to increasing the density of the negative active material layer because the metal nanoparticles may undergo a very large volumetric change during charging and discharging.

In contrast to the metal nanoparticles, the titanium-containing oxide undergoes a very small volumetric change during charging and discharging, and has a higher tap density than that of the metal nanoparticles. The titanium-containing oxide may contribute to increasing the density of the negative active material layer. Accordingly, an appropriate amount of the titanium-containing oxide may be used to secure the size and number of pores appropriate for achieving a negative active material layer having a density higher than 1.5 g/cc and lower than 3 g/cc. As a result, wettability by an electrolyte may be improved, and thus the high-rate characteristics and output characteristics of a battery may be improved.

In addition, since the titanium-containing oxide has a high average voltage at which lithium ions are intercalated/de-intercalated, resistance increasing films are prevented from forming on the titanium-containing oxide, and thus the battery may maintain a high capacity even when charged/discharged at a high rate.

As described above, a negative electrode according to embodiments including a current collector and a negative active material layer disposed on at least one surface of the current collector, wherein the negative active material layer includes a metal nanoparticle, a carbonaceous material, and a titanium-containing oxide, and the density of the negative active material layer is higher than 1.5 g/cc and lower than 3 g/cc improves the high-rate characteristics of the battery.

According to one or more embodiments, a battery having a high-density negative active material layer and exhibiting a high output may be realized.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof as set forth in the following claims.

What is claimed is:

1. A negative electrode for a lithium battery, the negative electrode comprising:
a current collector; and
a negative active material layer on at least one surface of the current collector,
wherein:
the negative active material layer includes a metal nanoparticle, a carbonaceous material, and a titanium-containing oxide, and
the density of the negative active material layer is greater than 1.5 g/cc and less than 3 g/cc.

2. The negative electrode for a lithium battery as claimed in claim 1, wherein the titanium-containing oxide includes a lithium titanium oxide represented by Formula 1 below:
LiₓTi_{y}M_{z}Oₙ <Formula 1>
wherein, in Formula 1, 1≦x≦4, 1≦y≦5, 0≦z≦3, and 3≦n≦12, and M is at least one element selected from the group of Li, Mg, Al, Ca, Sr, Cr, V, Fe, Co, Ni, Zr, Zn, Si, P, S, Y, Nb, Ga, Sn, Mo, W, Ba, La, Ce, Ag, Ta, Hf, Ru, Bi, Sb, and As.

3. The negative electrode for a lithium battery as claimed in claim 2, wherein the titanium-containing oxide includes at least one lithium titanium oxide selected from the group of Li₂TiO₃, Li₄Ti₅O₁₂, Li₂Ti₃O₇, LiCrTiO₄, LiFeTiO₄, Li₂TiSiO₅, LiTiPO₅, and LiTi₂(PO₄)₃.

4. The negative electrode for a lithium battery as claimed in claim 1, wherein the titanium-containing oxide includes a compound represented by Formula 2 below:
Ti_{y}M_{z}Oₙ <Formula 2>
wherein, in Formula 2, 1≦y≦2, 0≦z≦2, and 1≦n≦7, and M is at least one element selected from the group of Li, Mg, Al, Ca, Sr, Cr, V, Fe, Co, Ni, Zr, Zn, Si, P, S, Y, Nb, Ga, Sn, Mo, W, Ba, La, Ce, Ag, Ta, Hf, Ru, Bi, Sb, and As.

5. The negative electrode for a lithium battery as claimed in claim 4, wherein the titanium-containing oxide includes at least one compound selected from the group of TiO₂, TiSO₅, and TiP₂O₇.

6. The negative electrode for a lithium battery as claimed in claim 1, wherein the titanium-containing oxide includes a compound represented by Formula 3 below:
Liₓ₊₃F₃Ti_{y}O₁₂ <Formula 3>
wherein, in Formula 3, 2.4≦x≦4.2, and 4.8≦y≦6.6.

7. The negative electrode for a lithium battery as claimed in claim 6, wherein the titanium-containing oxide is an inactive material that does not intercalate or deintercalate lithium ions during charging and discharging of the lithium battery.

8. The negative electrode for a lithium battery as claimed in claim 6, wherein the titanium-containing oxide has electric conductivity.

9. The negative electrode for a lithium battery as claimed in claim 1, wherein an amount of the titanium-containing oxide is in a range of from about 1 wt % to about 20 wt % of a total weight of the negative active material layer.

10. The negative electrode for a lithium battery as claimed in claim 1, wherein the metal nanoparticle includes at least one selected from the group of Si, Sn, Al, Ge, Pb, Bi, Sb, an alloy thereof, and an oxide thereof.

11. The negative electrode for a lithium battery as claimed in claim 1, wherein the metal nanoparticle includes Si or SiOₓ (0<x<2).

12. The negative electrode for a lithium battery as claimed in claim 1, wherein the metal nanoparticle includes a carbon coating layer thereon.

13. The negative electrode for a lithium battery as claimed in claim 1, wherein an amount of the metal nanoparticle is from about 0.1 wt % to about 50 wt % of a total weight of the negative active material layer.

14. The negative electrode for a lithium battery as claimed in claim 1, wherein the carbonaceous material includes a crystalline carbon, an amorphous carbon, or a mixture thereof.

15. The negative electrode for a lithium battery as claimed in claim 1, wherein an amount of the carbonaceous material is from about 50 wt % to about 90 wt % of the total weight of the negative active material layer.

16. The negative electrode for a lithium battery as claimed in claim 1, wherein the negative active material layer further includes a binder.

17. The negative electrode for a lithium battery as claimed in claim 16, wherein the binder is selected from the group of polyvinylidenefluoride, polyvinylidenechloride, polybenzimidazole, polyimide, polyvinylacetate, polyacrylonitrile, polyvinylalcohol, carboxyl methyl cellulose (CMC), starch, hydroxypropyl cellulose, reclaimed cellulose, polyvinylpyrrolidone, tetrafluoroethylene, polyethylene, polypropylene, polystyrene, poly(methyl methacrylate, polyaniline, acrylonitrile-butadiene styrene resin, phenol resin, epoxy resin, polyethylene terephthalate, polytetrafluoroethylene, poly(phenylene sulfide), polyamidimide, polyether imide, polyethylene sulfone, polyamide, polyacetal, poly(phenylene oxide), polybutylene terephthalate, ethylene propylene diene monomer (EPDM), sulfonated EPDM, styrene-butadiene rubber (SBR), fluoro rubber, and a combination thereof.

18. The negative electrode for a lithium battery as claimed in claim 1, wherein the negative active material layer further includes a conductive material.

19. A lithium battery, wherein the lithium battery includes the negative electrode as claimed in claim 1.
